(19) United States
(12) Patent Application Publication
(10) Pub. No.: US 2014/0152771 A1
(43) Pub. Date: Jun. 5, 2014

(54) METHOD AND APPARATUS OF PROFILE MEASUREMENT

(71) Applicant: OG Technologies, Inc., Ann Arbor, MI (US)

(72) Inventor: Tzyy-Shuh Chang, Ann Arbor, MI (US)

(73) Assignee: OG Technologies, Inc., Ann Arbor, MI (US)

(21) Appl. No.: 14/091,970

(22) Filed: Nov. 27, 2013

Related U.S. Application Data
(60) Provisional application No. 61/793,366, filed on Mar. 15, 2013.
(60) Provisional application No. 61/732,292, filed on Dec. 1, 2012.

(51) Int. Cl. G01B 11/24; H04N 13/02; H04N 5/225

(52) U.S. Cl. CPC G01B 11/24; H04N 5/2254; H04N 13/0253
USPC 348/46; 348/135

(57) ABSTRACT

A system and method for profile measurement based on triangulation involves arrangement of an image acquisition assembly relative to an illumination assembly such that an imaging plane is parallel to a light plane (measurement plane defined by where the light plane impinges on the object), which supports uniform pixel resolution in the imaging plane. The image acquisition assembly includes an imaging sensor having a sensor axis and a lens having a principal axis, wherein the lens axis is offset from the imaging axis.

### CROSS REFERENCE TO RELATED APPLICATIONS

This application claims the benefit of U.S. provisional application No. 61/732,292, filed 1 Dec. 2012 (the '292 application), and U.S. provisional application No. 61/793,366, filed 15 Mar. 2013 (the '366 application). The '292 application and the '366 application are both hereby incorporated by reference as though fully set forth herein.

### BACKGROUND OF THE INVENTION

I. Technical Field

The instant disclosure relates generally to a system for imaging-based profile and/or dimensional measurement of an object.

II. Description of Related Art

This background description is set forth below for the purpose of providing context only. Therefore, any aspects of this background description, to the extent that it does not otherwise qualify as prior art, is neither expressly nor impliedly admitted as prior art against the instant disclosure.

Systems for imaging-based profile measurement of a two-dimensional (2D) and three-dimensional (3D) object are widely in use. One can find such imaging-based profile measurement systems in many applications, ranging from measurement, process control, modeling, to guidance.

Among many technical approaches, a very common technique is known as triangulation, in which a structured light pattern, such as a bright dot, a bright line, a cross, a circle, or a plural of them, or a combination of them, are projected onto an object surface of interest from one angle, and an imaging sensor, or more than one imaging sensor, is used to view the reflected light pattern(s) from a different angle. The angular difference will form the basis to solve for the distance(s) from the object surface that reflects the light pattern to the light pattern generating source. The imaging sensor is typically a camera, although other photo sensitive sensors may be used. The most common light source would be a laser, for generating a laser dot, a laser line, or other patterns. Other light sources generating similar lighting effect, known as structural lighting, can be used as well. Similar setup of the imaging sensor(s) is also applied to situations in which mechanical interference to another object, such as an ink-dispensing needle, may be avoided while taking measurements of the patterns on the plane perpendicular to the said object (e.g., the needle). A uniform area illumination, either directional (with predetermined incident angles) or non-directional (i.e., cloudy day illumination), may be used in this case.

The approach (having the imaging sensor at an angle to the lighting or lighted plane) is well known and well-practiced. However, this approach has some undesired characteristics. First, the angle difference between the projection of the light or light pattern (from the light source) and the viewing of the reflected light or light pattern by the imaging sensor, referred to as the measurement angle, is critical to the measurement resolution. Known approaches that use an angle less than 90 degrees enlarge the size in a portion and reduce that in another portion of an imaging plane; however, this results in a reduced overall image resolution. Second, the measurement angle also determines the complexity of the mathematical model in the triangulation calculations. For measurement angles less than 90 degrees, the model is complex in that it involves at least trigonometric transformations.

There is therefore a desire for an improved profile and dimension measurement system and method that overcomes one or more of the problems set forth above.

The foregoing discussion is intended only to illustrate the present field and should not be taken as a disavowal of claim scope.

### SUMMARY OF THE PRESENT INVENTION

Embodiments consistent with the teachings of the instant disclosure provide a system and method for profile and dimension measurement of an object that feature, at least, parallelism of a light plane or a lighted plane and an imaging plane (in which an image is captured) by virtue of an offset image acquisition assembly having, at least, a shifted lens.

In an embodiment, a system is provided for determining a profile of an object. The system includes an illumination assembly, an image acquisition assembly, and a data unit. The illumination assembly is configured to project a light plane onto an outer surface of the object. The image acquisition assembly includes an imaging sensor and a lens. The imaging sensor is configured to capture an image of an imaging plane wherein the imaging plane is substantially parallel to and lies in the light plane. The lens has a principal axis and is disposed between the light plane and the imaging sensor. The lens is positioned relative to the imaging sensor such that the principal axis is offset from a sensor axis wherein the sensor axis is substantially perpendicular to the imaging sensor and passes through a center of the imaging sensor. The data unit, typically a computer with a display or a display alone, is configured to receive the captured image and form the profile using at least the captured image.

A method of forming a profile of an outer surface of an object is also presented.

In another embodiment, a system is provided for determining the planar features of an object, such as the 2D projection dimensions or shapes when the principal axis (the axis perpendicular to and passing through the center of the object) is occupied by another object. The system includes an illumination assembly, an image acquisition assembly, and a data unit. The illumination assembly is configured to project a plane light onto the surface of the object and form the lighted plane. The image acquisition assembly includes an imaging sensor and a lens. The imaging sensor is configured to capture an image of an imaging plane wherein the imaging plane is substantially parallel to and lies in the lighted plane. The lens has a principal axis and is disposed between the lighted plane and the imaging sensor. The lens is positioned relative to the imaging sensor such that the principal axis is offset from a sensor axis wherein the sensor axis is substantially perpendicular to the imaging sensor and passes through a center of the imaging sensor. The data unit, typically a computer with a display or a display alone, is configured to receive the captured image and form the profile, contour or other planar features using at least the captured image.

The foregoing and other aspects, features, details, utilities, and advantages of the present disclosure will be apparent from reading the following description and claims, and from reviewing the accompanying drawings.

### BRIEF DESCRIPTION OF THE DRAWING

FIG. 1A is a diagrammatic and schematic view of an embodiment of a system for determining a profile of an object.

FIG. 1B is a diagrammatic view of an image captured using the system of FIG. 1A showing a segment corresponding to a portion of the object profile.

FIG. 1C is an enlargement of a portion of FIG. 1A.

FIG. 2 is an implementation instance of the data unit.

FIG. 3 is a diagrammatic and schematic view of an alternate arrangement for determining a profile of an object.

FIG. 4 is a diagrammatic and schematic view of a conventional laser triangulation profile measurement system.

FIGS. 5-7 are front, rear, and side diagrammatic views, respectively, of another embodiment of a system for determining a profile of an object that uses multiple offset image acquisitions assemblies suitable for determining a profile of a circumference of a three-dimensional object.

FIGS. 8A-8C are simplified diagrammatic views showing a plurality of separate profile segments on respective images captured using the embodiment of FIGS. 5-7, and which profile segments correspond to respective portions of the object profile.

FIG. 8D is a simplified diagrammatic view showing a combination of the plural segments of FIGS. 8A-8C.

FIG. 9 is a flowchart diagram showing a method of forming a profile of an object.

FIG. 10 illustrates a micro printer of current design.

FIG. 11 illustrates a micro printer employing the design of lens shift.

### DETAILED DESCRIPTION OF PREFERRED EMBODIMENTS OF THE PRESENT INVENTION

Before proceeding to a detailed description of the embodiments, a general overview will first be set forth of a system and method for profile measurement. As described in the Background, it is known to use a measurement angle of less than 90 degrees in profile measurement systems. The measurement resolution, however, as set forth herein, can be maximized when the measurement angle is 90 degrees, and in addition, the mathematical model(s) used to determine the object profile and dimension(s) become simplified when the measurement angle is 90 degrees. Known systems for profile measurement, however, particularly those with a scanning function, do not employ a measurement angle of 90 degrees. The reasons are at least two-fold.

First, it is more desirable to have either the light projection or the imaging sensor normal to the object surface being measured. This will reduce the mathematics of the scanning. Second, a large measurement angle may cause the hardware to interfere with the object being scanned, unless a good portion of the field of view is wasted. As a result, a typical profile measurement device based on triangulation is designed with a measurement angle of about 30 to 60 degrees. Some may even have an angle outside this range. As a result, the optical resolution in a measurement plane (i.e., the light traveling place of the projected light pattern), as viewed by an imaging sensor, will be location dependent. Namely, if the object surface intercepts the projected light pattern at different locations of the measurement plane, the measurement result in the pixel space will be different. Furthermore, there requires a depth of focus as the measurement plane deviates from the imaging plane. High optical resolution (typically with shallower depth of focus) may limit the measurement range or result in additional measurement variations. For objects that are steady, this may not be very critical. However, for some applications, the object to be measured may move substantially in the measurement plane, the true three-dimensional (3D) calibration may be an issue.

Embodiments according to the teachings of the instant disclosure employ a measurement angle of substantially 90 degrees so that the pixel resolution in the measurement plane will be substantially uniform. In addition, a greater portion of the active imaging area on an imaging sensor will be usable for imaging in the measurement plane, thereby increasing resolution (i.e., pixels used for capture on the object, for example, all or at least most of the pixels). Embodiments according to the instant teachings are characterized by a system for profile measurement—using triangulation—that employs a measurement angle of substantially 90 degrees (or substantially so) as well as fully utilizing the imaging sensor's active imaging area.

Embodiments of a system for determining a profile of an object (e.g., may be a three-dimensional object) may be used for a number of useful purposes, for example, in a manufacturing process to confirm or validate that the manufacture of an object conforms to a predetermined shape and/or predetermined dimensional specifications. For example only, such a profiling system may be used to determine the “roundness” of a round object, or to determine the “shape” of a non-round object, like an H-beam or a rail. Embodiments of a profiling system according to the present teachings may be used for determining the actual shape of a steel object.

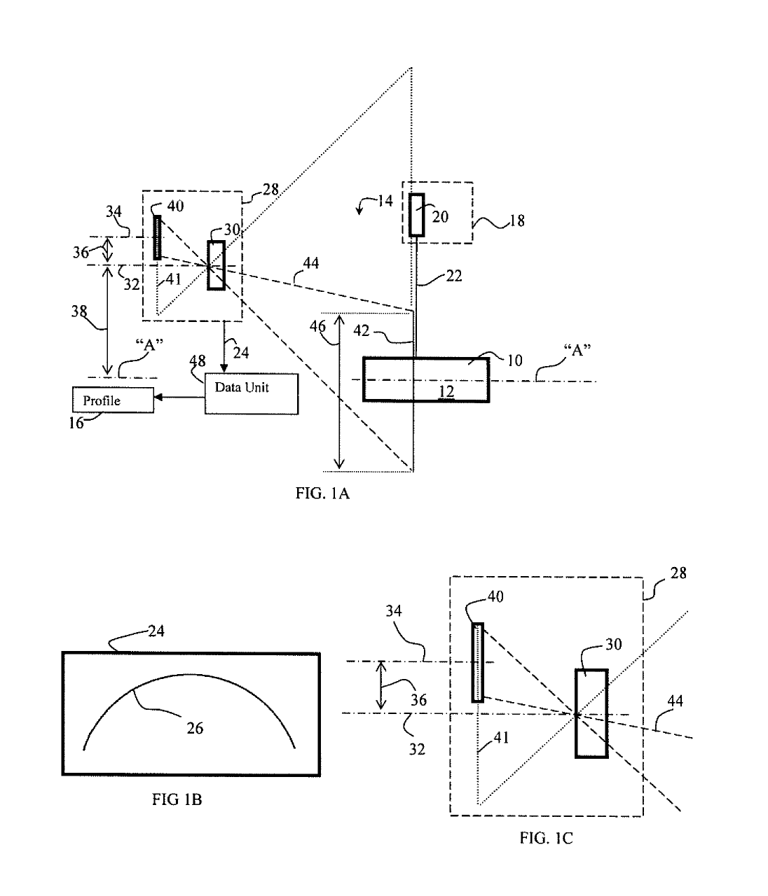

FIGS. 1A and 1C are diagrammatic and schematic diagram views of an embodiment of a profiling system 14 in accordance with the instant teachings, for determining a profile 16 of a three-dimensional object 10 having an outer surface 12. Object 10 may extend along a longitudinal axis designated “A”. In the illustrated embodiment, system 14 includes an illumination assembly 18, an image acquisition assembly 28, and a data unit 48.

Illumination assembly 18 includes at least a line source 20, such as a laser line or other light line sources having the same effect, configured to project a light plane 22 onto surface 12 of object 10. The line source 20 can be of any wavelength or a combination of multiple wavelengths, in the areas of infrared, visible light or ultraviolet or known in the range from 0.01 micron to 1000 microns, suitable for the selected imaging sensor and lens. The instant invention, without losing generality, will adopt the term “laser” as the line source 20. Light plane 22 is also known as the measurement plane described above. In the illustrated embodiment, source 20 is arranged relative to object 10 such that light plane 22 is substantially perpendicular to outer surface 12 of object 10, and thus the longitudinal axis “A”. In this case, the light plane and the measurement plane (i.e., the plane in which the light plane impinges onto the object's surface) will be the same. Light plane 22 interacts with surface 12 of object 10, where it can be imaged by image acquisition assembly 28 as will be described below. It should be understood that the light plane 22 may be formed by more than one line source 20 if the cross-section geometry of object 10 requires lighting from multiple angles of illumination to extract the profile or a segment of the profile of object 10, and the light emitted by multiple line sources 20 lies substantially in the light plane 22.

Image acquisition assembly 28 comprises a lens 30 (e.g., a converging lens or a lens of similar function) and an imaging sensor 40, both of which may comprise conventional construction. For example only, imaging sensor 40 may comprise a charge-coupled device (CCD), a complementary metal-oxide semiconductor (CMOS) device, or a video camera tube, to name a few. Image acquisition assembly 28 is configured to capture an image 24 (best shown in FIG. 1B) of a focused imaging plane 42, which image 24 will contain a profile segment 26 corresponding to a portion of profile 16 being imaged by image acquisition assembly 28. In the illustrated embodiment, image acquisition assembly 28, particularly lens 30 and imaging sensor 40, are arranged relative to source 20 so that focused imaging plane 42 lies substantially in the measurement plane where light plane 22 interacts with outer surface 12 of object 10. In other words, focused imaging plane 42 is substantially parallel to and lies in light plane 22 (i.e., the measurement plane in the illustrated embodiment).

In addition, lens 30 is off-centered relative to imaging sensor 40, as if imaging sensor 40 were larger (illustrated as the dotted line 41 in FIG. 1A, and better zoomed-in for details in FIG. 1C) and centered with lens 30. Lens 30 has a principal axis 32 associated therewith. In addition, imaging sensor 40 also has a sensor axis 34 associated therewith that is substantially perpendicular to plane of imaging sensor 40 and passes through a center of imaging sensor 40. The offset is achieved by disposing lens 30 between light plane 22 and imaging sensor 40 such that principal axis 32 is offset from sensor axis 34 by a first predetermined distance 36. Image acquisition assembly 28 (i.e., lens/sensor) is radially offset from longitudinal axis “A” by a second predetermined distance 38. As a result of these relationships, imaging plane 42 is characterized by a predetermined size/range 44, as shown by the volume enclosed by the expanding dashed-lines in FIG. 1A. The size of imaging plane 42 may be described in two dimensions, for example, as a third predetermined distance 46 in the vertical dimension or the Y-axis and a further predetermined distance in the horizontal dimension or the X-axis (not shown in FIG. 1A, but would be taken as extending into/out from the paper). In practice, one can position the lens 30 centered to the dotted line 41 (assumed larger imaging sensor) for a larger field of view in which the intended imaging plane 42 lies, and then position the actual imaging sensor 40 within the dotted line 41 at a position such that the actual field of view is mapped to the intended imaging plane 42. Those skilled in the art would appreciate that the fact that the size and position of imaging plane 42 is determined by the size and position of imaging sensor 40, the optical properties of lens 30, the predetermined distances and known optical rules such as line of sight.

Data unit 48 is configured to receive and process image 24 from image acquisition assembly 28 and form profile 16. In an embodiment, the data unit 48 is a video signal organizing device, such as a video multiplexer, that can distribute the image from an image acquisition assembly 28 to the corresponding display (not shown in FIG. 1) suitable for user observation of the profile 16. Profile segment 26 corresponds to a portion of profile 16 and indicates where light plane 22 impinges on outer surface 12 of object 10. Therefore, a plural number of image acquisition assemblies 28 generating a plural number of profile segments 26 may be arranged on a plural number of displays (not shown in FIG. 1) such that the profile segments 26 form a full profile 16 of object 10 on the displays.

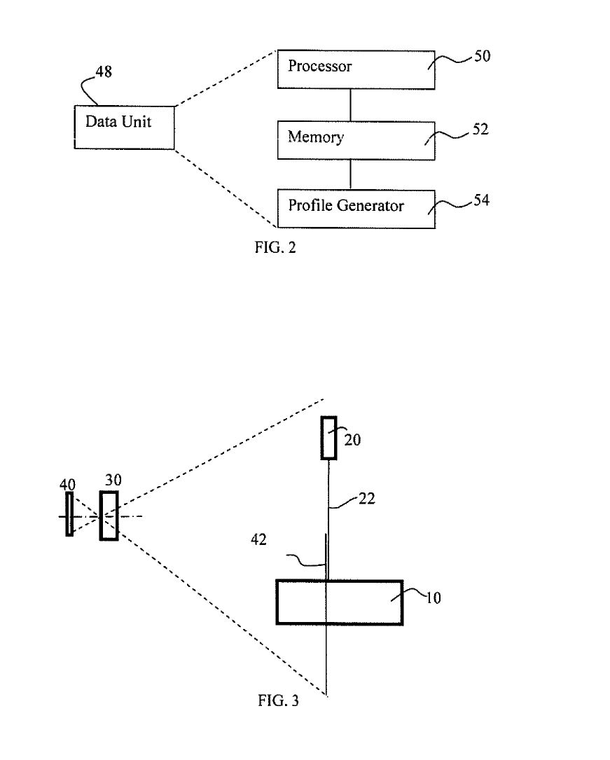

However, those skilled in the art shall appreciate the advancement in the electronic processing field and understand that an alternative embodiment, as illustrated in FIG. 2, is for the data unit 48 to include one or more electronic processor(s) 50, which may be of conventional construction, as well as an associated memory 52, which may also be of conventional construction. The data unit 48 may further includes a profile generator 54, which in an embodiment may comprise software stored in memory 52, which when executed by processor(s) 50, is configured with prescribed procedures and transformation models to process image 24 and determine a profile segment 26 contained in image 24 (best shown in FIG. 1B). In such an embodiment, a plural number of image acquisition assemblies 28 generating a plural number of profile segments 26 may be arranged such that the profile segments 26 form a full profile 16 of object 10 in the data unit 48 prior to the display. In yet another alternate embodiment, profile generator 54 may include, in whole or in part, computing hardware in substitution of, or in support of, software, for performing the functions described herein.

Referring now to FIGS. 1A-1C, embodiments consistent with the instant teachings are advantageous because the imaging plane 42 is parallel to the light plane 22. This relationship will result in a linear measurement model and a uniform pixel resolution in the measurement plane. There could be the optimized focus on the measurement plane for the best measurement result as the measurement plane does not deviate from the imaging plane 42. That is, the required depth of focus in the instant teaching is substantially close to 0. This is particularly suitable for the applications involving high optical resolutions. This arrangement will also simplify the three-dimensional (3D) calibration when plural profile segments are combined to form a complete profile, as described below in greater detail. The offset of lens 30 relative to imaging sensor 40 (and object 10) properly positions imaging plane 42 with respect to imaging sensor 40 so that the complete range 44 (i.e., the size of the imaging plane 42) is fully usable for profile measurement on object 10 while providing a clear moving path for object 10 along the axis “A” without otherwise interfere with other objects such as the image acquisition assembly 28.

FIG. 3 shows an alternate arrangement that does not fully achieve the advantages of the embodiment of FIG. 1A. Where lens 30 is positioned in a typical centered position (i.e., the principal lens axis is coincident with the sensor axis), as illustrated in FIG. 3, imaging plane 42 will have a larger range, which is shown having a larger vertical extent as compared to the embodiment of FIG. 1A. However, this alternate arrangement achieves a less desirable optical resolution, as approximately 50% or more of imaging plane 42 along the Y axis alone as shown in FIG. 3 will not be usable because of the horizontal interference to the imaging sensor 40 (and lens 30 as well).

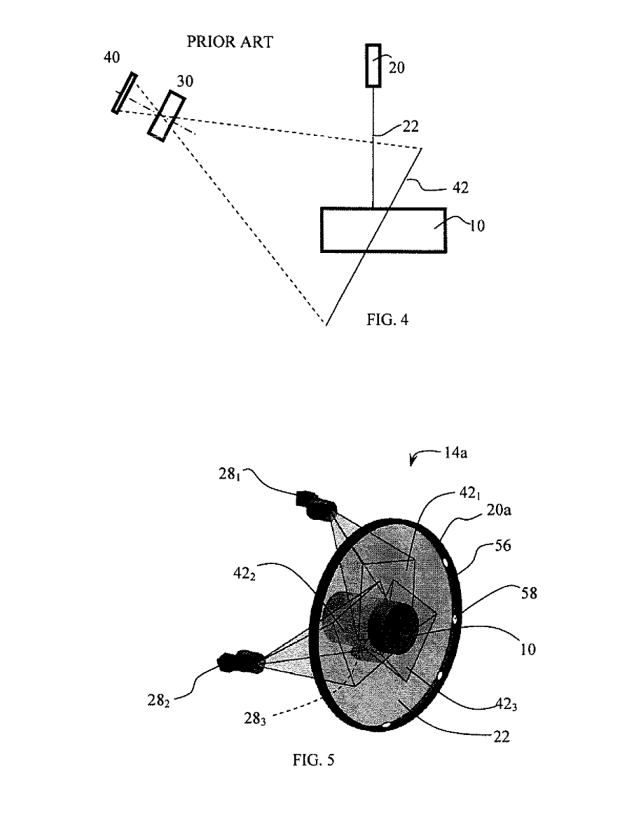

FIG. 4 shows a conventional arrangement of a profile measurement setup known in the art. Imaging plane 42 in FIG. 4 is not parallel to the measurement plane. While in this arrangement the pixel resolution in imaging plane 42 is uniform, the projected pixel resolution onto the measurement plane, as viewed by imaging sensor 40, will not be uniform.

In further embodiments, a profiling system (hereinafter system 14a) incorporates a modified illumination assembly 18 configured to project a light plane around the circumference of the object as well as multiple image acquisition assemblies 28 configured to image around the circumference of the object. System 14a, thus configured, is able to profile completely around the entire circumference of the object.

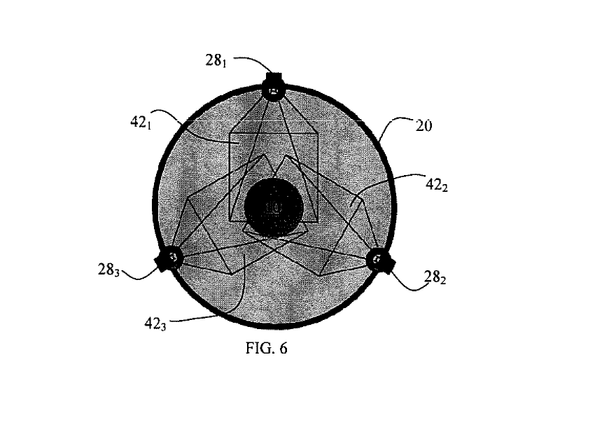

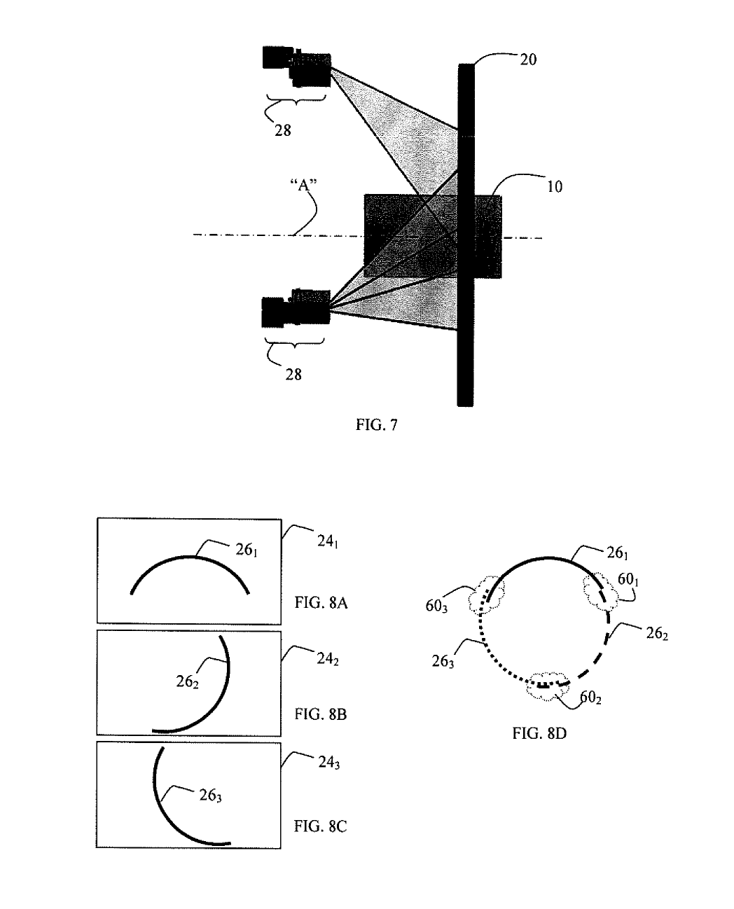

FIGS. 5-7 are isometric views of a system 14a for determining a profile around the entire circumference of a three-dimensional object 10. System 14a includes a light plane source 20a similar to light line source 20 in FIG. 1A but which is specifically configured to project light plane 22 around the entire circumference of object 10. In an embodiment, light plane source 20a include an annular (i.e., ring) body 56 around which a plurality of lasers 58 are disposed. Each laser 58 produces a respective laser line. The lasers 58 are arranged on ring body 56 and aligned—each one with respect to the others—such that the plurality of laser lines generated by lasers 58 all lie substantially in light plane 22.

System 14a further includes a plurality of image acquisition assemblies 28 like that shown in FIG. 1A. As an example, without losing the generality, the illustrated embodiment of system 14a includes three image acquisition assemblies 28₁, 28₂, and 28₃ arranged circumferentially with respect to longitudinal axis “A”. Each image acquisition assembly 28₁, 28₂, and 28₃ is radially offset from axis “A” by second predetermined distance 38 (just like assembly 28 in FIG. 1A). In the illustrated embodiment, the three image acquisition assemblies 28₁, 28₂, and 28₃ are arranged at approximately 120 degree intervals (evenly around axis “A”).

It should be understood, however, that while three image acquisition assemblies 28₁, 28₂, and 28₃ are used in the illustrated embodiment for complete profiling of a round object, more or less image acquisition assemblies may be used in other embodiments, depending on at least (i) the shape of the object, and (ii) the desired output profile. For example, in some embodiments, six, seven, eight or more image acquisition assemblies may be used, for example, for certain complex shapes, such as an “H” shaped beam or rail. The adoption of multiple image acquisition assemblies shall be optimized based on the cross-section geometry of object 10. The positions of the assemblies 28 may or may not be evenly spaced around the circumference of object 10. The second predetermined distances 38 for the assemblies 28 may be individually selected for each of the assemblies 28 and do not require to be same.

Each of the image acquisition assemblies 28₁, 28₂, and 28₃ captures a respective image 24₁, 24₂, 24₃ (best shown in FIGS. 8A-8C) of a respective imaging plane 42₁, 42₂, and 42₃. Although not shown in FIGS. 5-7, system 14a also includes data unit 48 like that in system 14 (FIG. 1A) to process images 24₁, 24₂, 24₃ together to form profile 16. Object 10, in some embodiments, may be moving along an axis “A” rather than being stationary.

One advantage to the offset image acquisition assemblies relates to the ease with which multiple pieces of data (image 24₁, 24₂, 24₃) can be processed and integrated to form a composite profile 16. In conventional arrangements, each image acquisition assembly will have its own 3D trigonometric calibration function. In such arrangements, having 3, 4 or even 8 imagers will greatly complicate the overall system calibration process very quickly.

In embodiments consistent with the teachings of the instant disclosure, the profile data—the profile segments—obtained from each image 24₁, 24₂, 24₃ can be more easily tied together or mapped to form a composite profile, due to the availability of 2-dimensional (2D) uniform mapping. In the embodiments, the integration of multiple (e.g., three) data sets from multiple image acquisition assemblies require only a two-dimensional planar calibration of the laser plane, not a three-dimensional non-linear calibration as in the conventional art. The overlapping of at least certain portions of the focused imaging planes, designated 42₁, 42₂, 42₃, allows data unit 48 to perform the calibration in 2D, based on at least the overlapping portions of the profile segments from the image acquisition assemblies.

FIGS. 8A-8C are simplified representations of images 24₁, 24₂, 24₃ obtained from respective image acquisition assemblies 28₁, 28₂, and 28₃ where each of the images 24₁, 24₂, 24₃ contains or otherwise shows a respective profile segment 26₁, 26₂, 26₃. With respect to system 14a, the profile generator 54 (executing in data unit 48) is configured to determine first, second, and third profile segments 26₁, 26₂, 26₃ respectively in the first, second, and third images 24₁, 24₂, 24₃. The profile segments 26₁, 26₂, 26₃ respectively corresponding to first, second, and third portions of the composite profile 16 of object 10. Each of the first, second, and third profile segments 26₁, 26₂, 26₃ may comprise a respective two-dimensional profile segment, as shown.

FIG. 8D is a diagrammatic view of a composite profile 16. Profile 16 may be formed by profile generator 54 (executing on data unit 48). To determine the composite profile, profile generator 54 may be further configured with a calibration process that identifies common points and geometric features between any two adjacent profile segments. As an example shown in FIG. 8D, without losing the generality, profile generator 54 may identify (i) a first common point 60₁ between first profile segment 26₁ and second profile segment 26₂, (ii) a second common point 60₂ between second profile segment 26₂ and third profile segment 26₃, and (iii) a third common point 60₃ between first profile segment 26₁ and third profile segment 26₃. The profile generator 54 is still further configured to form profile 16 of object 10 by using at least the first, second, and third profile segments 26₁, 26₂, and 26₃ in accordance with at least the identified first, second, and third common points 60₁, 60₂, and 60₃, along with other dimensional and geometric features (such as the diameter) of object 10. It should be appreciated that, in an embodiment, that the first, second, and third images 24₁, 24₂, 24₃ may be first registered to a common coordinate system. It should also be appreciated that the profile segment 26 may be a portion of a polygon like a square or a hexagon, if the cross-section of object 10 is a polygon, such that the common points and other dimensional and geometric features (such as the angles and the length of edges) be easier identified during the calibration process. If an object 10 with known dimensional and geometric features is provided, the calibration process will result in a transformation model that transforms the profile segment 26 generated from the image acquired by an image acquisition assembly 28 into a profile segment 26’ in the coordinate system in which the composite profile 16 be constructed. Each image acquisition assembly 28 will have its own unique transformation model such that profile segments 26 from different image acquisition assemblies 28 be transformed into the same coordinate system for merging into the composite profile 16. The calibration process as described may serve a system with N image acquisition assemblies 28, where N is an integer equal to or greater than 2.

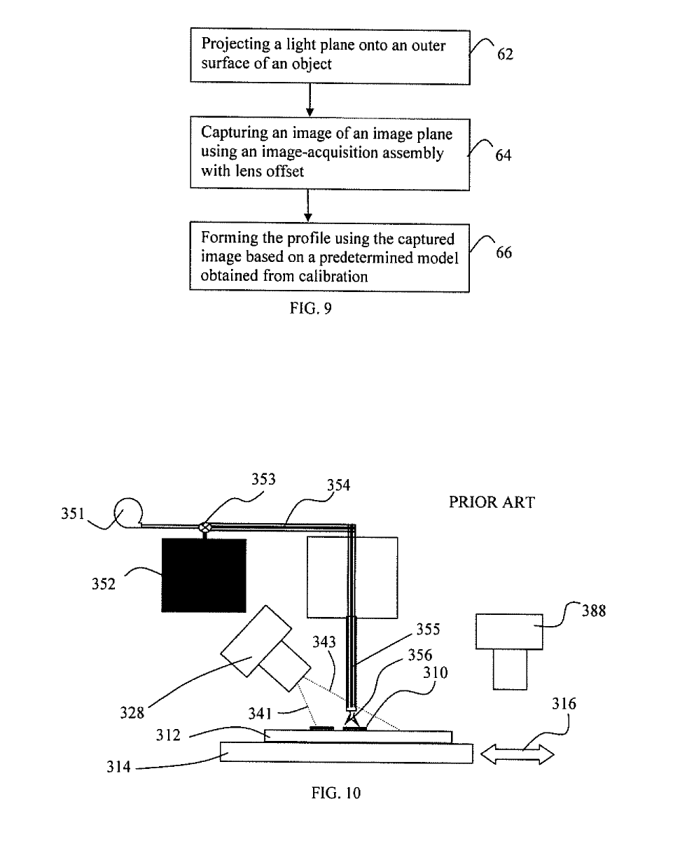

FIG. 9 is a flowchart diagram illustrating a process performed by system 14 (or 14a) to determine a profile of a three-dimensional object. The process begins in step 62.

Step 62 involves projecting a light plane onto an outer surface 12 of an object 10. Step 62 may be performed substantially as described in the embodiments set forth above, for example, by operating at least a light line source to produce a light plane 22 (e.g., as in system 14), or expanding the approach to produce a light plane 22 that impinges onto the object around the object's entire circumference (e.g., as in system 14a). The process proceeds to step 64.

Step 64 involves capturing an image of an imaging plane using an offset image acquisition assembly. Step 64 may be performed substantially as described in the embodiments set forth above. The imaging plane 42 will be substantially parallel to the light plane/measurement plane, and the principal axis of the lens will be offset from the sensor axis, all to achieve the above-described beneficial effects. In some embodiments, a single image acquisition assembly may be used to capture an image, while in other embodiments, multiple image acquisition assemblies may be used to capture plural images. The process then proceeds to step 66.

Step 66 involves forming the profile of an object, which can be a three-dimensional object, using the captured image or images from step 64. Step 66 may be performed substantially as described in the embodiments set forth above. For example, in an embodiment of system 14a, step 66 may be performed by profile generator 54 by (i) determining the profile segments in the captured images, (ii) applying the transformation models obtained from the calibration process to the profile segments, and (iii) combining the profile segments.

The system 14a can be configured in a different embodiment, in that each image acquisition assembly 28 is individually coupled with one illumination assembly 18 and form a profile scanner. Within a profile scanner, the relationship between the illumination assembly 18 and the image acquisition assembly 28 is fixed. Multiple profile scanners can be used to form a system having the same function of system 14a. To avoid interference of light plane(s), those skilled in the art shall know that each profile scanner may equipment with a light plane of a unique wavelength and a corresponding optical filter may be used to select the light plane of interest to the specific profile scanner. Another approach is to offset different profile scanners along the axis “A”.

The profiling functionality of the instant teachings may be used by itself and/or in combination with additional optical imaging functionality, such as surface inspection, such as performed by a surface inspection apparatus, for example, like the inspection apparatus described in U.S. application Ser. No. 10/331,050, filed 27 Dec. 2002 (the '050 application), now U.S. Pat. No. 6,950,546, and U.S. application Ser. No. 12/236,886, filed 24 Sep. 2008 (the '886 application), now U.S. Pat. No. 7,627,163. The '050 application and the '886 application are both hereby incorporated by reference as though fully set forth herein.

It should be understood that system 14 (and system 14a), particularly a main electronic control unit (L e., data unit 48), as described herein, may include conventional processing apparatus known in the art, capable of executing pre-programmed instructions stored in an associated memory, all performing in accordance with the functionality described herein. Such an electronic control unit may further be of the type having both ROM, RAM, a combination of non-volatile and volatile (modifiable) memory so that any software may be stored and yet allow storage and processing of dynamically produced data and/or signals. It should be further understood that the terms “top”, “bottom”, “up”, “down”, and the like are for convenience of description only and are not intended to be limiting in nature.

While one or more particular embodiments have been shown and described, it will be understood by those of skill in the art that various changes and modifications can be made without departing from the spirit and scope of the present teachings.

The teaching of the instant invention is also advantageous in view of other applications such as in-line measurement and monitoring for micro-printing or 3D printing. Without losing the generality, the printing of micro antenna on a substrate using an aerosol needle is employed as an example. FIG. 10 illustrates the existing design of a micro antenna printer. A substrate 312 is typically mounted on an XY table 314, which may move by command to carry the substrate 312 to desired positions with respect to other fixed devices in the printer. A pump 351 that supplies pressured air, having the ability to control the purity, content, pressure, volume and flow rate of the pressured air, is typically included. The pressured air may mix the ink, which is a mixture of the deposit material and the solvent, from a container 352 through the venturi effect at a device 353. Device 353 may include a valve that allows control on the ratio of air/ink mixture 354. The air/ink mixture flow is moving into a needle 355, typically fixed in the printer, and escapes from the end of the needle as the aerosol spray 356. The air acts as the carrier of the ink, and the ink will stay on the surface of the substrate at the designated location and form the desired layer of antenna material 310. The control of the air/ink flow and the XY table motion will form the antenna pattern on the substrate 312.

In order to verify the printing quality in terms of whether the antenna pattern is in conformity to the design specification, an image acquisition assembly 328 is typically employed. While the illumination can be well designed in the application to project uniform illumination onto the area of interest on the substrate 312, using either a directional (e.g., dark field or coaxial lighting) or non-directional (e.g., cloudy day lighting) approach, the assembly 328 is disposed such that its principal axis is at an angle to the principal axis of the aerosol needle, to avoid the mechanical interference. Due to this angle, the distance of the substrate 312 to the image acquisition assembly 328 is location dependent and may vary significantly. As illustrated in FIG. 10, the left side field of view distance 341 is substantially less than the right side field of view distance 343. As a result, the image quality is often improper for the printer. The varied distances (341/343) cause different pixel resolution in the image. Furthermore, the scale of the printing is often in the range of sub-micron to several microns and the depth of focus is so shallow under this optical resolution. Shallow depth of focus limits the use of the image acquired from assembly 328. In the conventional practice, a second image acquisition assembly 388, whose principal axis is offset from the aerosol needle and perpendicular to the substrate 312, is required for the purpose of accurate dimensional measurement and inspection of the printed antenna pattern. However, the second assembly 388 cannot provide any information during printing.

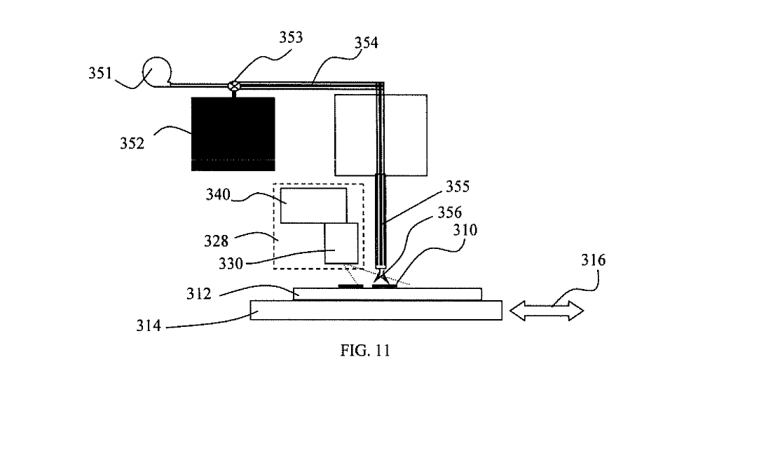

The instant invention may be employed to solve this issue. FIG. 11 illustrates the embodiment, a system used to determine the planar features of the printed object 310, such as the 2D projection dimensions or shapes, when the principal axis, the axis perpendicular to and passing through the center of the printed object 310, is occupied by another object like the aerosol needle 355. The system includes an image acquisition assembly 328. The system may further include an illumination assembly (not shown in FIG. 11) configured to project a plane light onto the surface of the object 312 and form the lighted plane. The light can be of any wavelength or a combination of multiple wavelengths, in the areas of infrared, visible light or ultraviolet or known in the range from 0.01 micron to 1000 microns, suitable for the selected imaging sensor and lens. The image acquisition assembly 328 includes an imaging sensor 340 and a lens 330. The imaging sensor 340 is configured to capture an image of an imaging plane wherein the imaging plane is substantially parallel to and lies in the lighted plane. The lens 330 has a principal axis and is disposed between the lighted plane and the imaging sensor 340. The lens 330 is positioned relative to the imaging sensor 340 such that the principal axis is offset from a sensor axis wherein the sensor axis is substantially perpendicular to the imaging sensor 340 and passes through a center of the imaging sensor 340. A data unit (not shown in FIG. 11) may be included and configured to receive the captured image and provide observation or processing of at least the captured image for at least monitoring, measurement and/or defect detection.

Those skilled in the art shall appreciate that external illumination may not be necessary. The self-emitting radiation, infrared, visible light or ultraviolet, depending on the material and temperature of the object to be imaged, may be captured by an image acquisition assembly properly selected to receive such radiation. For example, a CCD sensor may be used for short-wavelength infrared and visible light, and a microbolometer sensor may be used for long-wavelength infrared.

I claim:

1. A system for generating a three-dimensional profile of an object, comprising:
an illumination assembly configured to project a light plane onto an outer surface of the object;
an image acquisition assembly comprising an imaging sensor and a lens, said imaging sensor having an image plane and being configured to capture an image on an imaging plane wherein said imaging plane is substantially parallel to and lies in said light plane, said lens having a principal axis and is disposed between said light plane and said imaging sensor, said lens being positioned relative to said imaging sensor such that said principal axis is offset from a sensor axis wherein said sensor axis is substantially perpendicular to said imaging sensor and passes through a central portion of said imaging sensor; and
a data unit configured to receive said image and form said three-dimensional profile therefrom.

2. The system of claim 1 wherein said lens is positioned between said light plane and said imaging sensor such that a size of said imaging plane projected on said light plane has no interference with said imaging sensor and said lens in a direction perpendicular to said light plane.

3. The system of claim 1 wherein said lens is positioned relative to said imaging sensor to form said imaging plane of a predetermined size on said light plane.

4. The system of claim 1 wherein said lens comprises a converging lens.

5. The system of claim 1 wherein said illumination assembly is further configured to project said light plane from at least one line light source.

6. The said line light source of claim 5 comprises a line light source in selected from the group comprising a laser, a structural lighting source, and a line-shape light projector.

7. The system of claim 1 where in said illumination assembly is further configured to project said light plane completely around the outer surface of the object, and wherein said image acquisition assembly is a first image acquisition assembly and said image is a first image, said first image acquisition assembly being radially offset by a first predetermined distance from a longitudinal axis along in which the object is disposed, said system further including:
an Nth image acquisition assembly, where N is an integer equal to or greater than 2, configured to respectively capture the Nth image of the Nth imaging plane that lies within said light plane, and wherein said Nth image acquisition assembly is radially offset from said longitudinal axis by an Nth predetermined distance, and said N image acquisition assemblies being circumferentially-arranged relative to said longitudinal axis such that said N imaging planes collectively completely span the circumference of the object.

8. The system of claim 7 wherein said N image acquisition assemblies are circumferentially-arranged at approximately evenly spaced along the 360° circumference.

9. The system of claim 7 wherein said data unit comprises at least one electronic processor, said data unit further including a profile generator stored in memory for execution by the at least one electronic processor, said profile generator being configured to determine respective segments in said images, transform said segments using predetermined respective models obtained from calibration, and form said profile using said segments.

10. The system of claim 7 wherein said N images are registered to one single coordinate system.

11. The registration in claim 10 is based on said N images taken from a calibration object of a polygon cross-section profile.

12. The system of claim 1 wherein said illumination assembly comprises a plurality of lasers each producing a laser line, wherein said plurality of lasers are arranged on a ring and aligned such that said plurality of laser lines lie in said light plane.

13. The system of claim 1 wherein said imaging sensor comprises a sensor in selected from the group comprising a charge-coupled device (CCD), a complementary metal-oxide semiconductor (CMOS) device, and a video camera tube.

14. The system of claim 1 where said illumination assembly is arranged relative to the object such that said light plane is substantially perpendicular to said outer surface of said object.

15. A method of forming a profile of an outer surface of an object, comprising the steps of:
projecting a light plane onto an outer surface of the object;
capturing an image of an imaging plane that is substantially parallel to and lies in the light plane using an offset imaging acquisition assembly comprising an imaging sensor and a lens wherein the lens has a principal axis and is disposed between the light plane and the imaging sensor and wherein the lens is positioned relative to the imaging sensor such that the principal axis is offset from a sensor axis that is substantially perpendicular to the imaging sensor and passes through a central portion thereof; and
forming, using a data unit, the profile using at least the captured image.

16. The method of claim 15 wherein projecting further comprises the step of projecting the light plane completely around the outer surface of the object.

17. The method of claim 15 further comprising a plurality of offset image acquisition assemblies each capturing a respective image of a respective imaging plane that lies in the light plane, the method further comprising the steps of:
determining respective segments in the plurality of captured images, transforming the segments using predetermined respective models obtained from calibration, and forming the profile using the segments.

18. The method of claim 15 wherein the offset image acquisition assembly is a first image acquisition assembly and the image is a first image, the method further comprising the steps of:
capturing the Nth image of Nth imaging plane that lies in said light plane using Nth offset image acquisition assembly, respectively, where N is an integer equal to or greater than 2;
determining N segments respectively in the N images wherein the Nth segments respectively correspond to Nth portions of the profile of the object and wherein each of the N segments comprises a respective two-dimensional segment;
transforming each of the N segments using a corresponding predetermined model obtained from calibration; and
forming the profile of the object using the N segments.

19. The method of claim 18 wherein the N images are registered to one single coordinate system.

20. The registration in claim 19 is based on said N images taken from a calibration object of a polygon cross-section profile.

21. A system for generating a planar image of an object, comprising:
an illumination assembly configured to project light onto and form a lighted plane on a surface of the object; and
an image acquisition assembly comprising an imaging sensor and a lens, said imaging sensor having an imaging plane and being configured to capture an image on said imaging plane wherein said imaging plane is substantially parallel to and lies in said lighted plane, said lens having a principal axis and is disposed between said lighted plane and said imaging sensor, said lens being positioned relative to said imaging sensor such that said principal axis is offset from a sensor axis wherein said sensor axis is substantially perpendicular to said imaging sensor and passes through a central portion of said imaging sensor.

22. The system of claim 21 further includes a data unit configured to received said planar image for the purpose of displaying, storing, processing, analyzing or any combination of the aforementioned purposes.

23. The system of claim 21 wherein said lens is positioned between said lighted plane and said imaging sensor such that a size of said imaging plane projected on said lighted plane has a center axis that is perpendicular to said lighted plane and offset from the center axis of said imaging sensor at a predetermined distance.

24. The system of claim 21 wherein said lens is positioned relative to said imaging sensor to form said imaging plane of a predetermined size on said lighted plane.

25. A method of forming an image of an off-axis surface, comprising the steps of:
projecting light onto a surface of the object and forming a lighted plane; and
capturing an image of an imaging plane that is substantially parallel to and lies in the lighted plane using an offset imaging acquisition assembly comprising an imaging sensor and a lens wherein the lens has a principal axis and is disposed between the light plane and the imaging sensor and wherein the lens is positioned relative to the imaging sensor such that the principal axis is offset from a sensor axis that is substantially perpendicular to the imaging sensor and passes through a central portion thereof.

26. The method of claim 25 further includes a procedure of using a data unit configured to receive said image for the purpose of displaying, storing, processing, analyzing or any combination of the aforementioned purposes.
